(19) United States
(12) Patent Application Publication
(10) Pub. No.: US 2023/0410017 A1
(43) Pub. Date: Dec. 21, 2023

(54) METHOD AND SYSTEM FOR AUTOMATICALLY PROVIDING SUSTAINTABILITY SCORE FOR PRODUCTS

(71) Applicant: FIRSTPLANIT LTD, London (GB)

(72) Inventors: Ankita DWIVEDI, London (GB); Sanjoli TUTEJA, London (GB); Pratik GHOLKAR, London (GB); Bethania LANZARO, London (GB); Dimitrios ANGELETOS, London (GB); Sadaf SALEHI, London (GB)

(73) Assignee: FIRSTPLANIT LTD, London (GB)

(21) Appl. No.: 18/035,406

(22) PCT Filed: Nov. 2, 2021
(86) PCT No.: PCT/GB2021/052832

§ 371 Date: May 4, 2023

(30) Foreign Application Priority Data
Nov. 4, 2020 (GB) 2017448.8

(51) Int. Cl. G06Q 10/0637; G06Q 30/018

(52) U.S. Cl. CPC G06Q 10/06375; G06Q 30/018

(57) ABSTRACT

According to the present disclosure, a system and method for automatically providing an impact index for a product or a material across a plurality of impact dimensions are disclosed. The method comprises the steps of selecting at least one product from a plurality of products, identifying a plurality of attributes related to a plurality of impact dimensions for the at least one product selected, selecting at least one set of attributes from the plurality of attributes for the at least one product selected, mapping the at least one set of attributes to a plurality of variables related to each of the plurality of impact dimensions, determining a plurality of weightages for the plurality of variables and the plurality of attributes and automatically determining an impact index, which is a sustainability score, of the at least one product for each of the plurality of impact dimensions using the plurality of weightages.

### TECHNICAL FIELD

The present disclosure described herein, in general, relates to the evaluation of materials, and more particularly to a system and method for providing impact and sustainability score of materials and products across plurality of impact dimensions.

### BACKGROUND

Consumers often decide whether to buy a product based on many factors that include product features, price, or performance of the product. Consumers also consider whether a product is consistent with sustainability values, for example environmental, moral and personal values. Sustainability generally relates to an ability to maintain a desired balance between utilization of resources vis-à-vis the availability or the projected availability of resources. In addition, consumers and Industries may also consider whether to purchase a product based on the product's country of origin or a particular region. In one example of products selection, building material and products may be considered by the industries or consumers. The building and construction industry is one of the One of the major industries contributing about 30% to the global CO₂ emissions. Further building and construction activities are also responsible for about 40% of the energy consumption. Moreover, buildings and construction also impacts the environment including land use, biodiversity damages, and material and water consumption. Consequently, holistic sustainable decision making that covers several impact dimensions such as Environmental, Social, Health and Monetary is the need of the hour in an industry.

Multiple digital tools, standards, certifications, and ratings systems offer solution for aspects of sustainability. For e.g. The US application 20100100405A1 discloses a method and apparatus for determining and managing sustainability ratings. The method as disclosed recites receiving a construction product type. Further a first candidate is identified for construction product type from a database wherein the first candidate at least in partially suitably to the construction product type. Further the first candidate construction product is associated with sustainability data for the first candidate construction product. A first sustainability rating is determined based at least in part on the sustainability data for the first candidate construction product through application of sustainability rules. However, the reference determines sustainability from energy consumption aspect only. It fails to consider the impacts across the environment, health, monetary and social dimensions.

Further another exemplary disclosure discloses a sustainability engine responsible for evaluating the compliance or rating of the architectural structure based on the impact of selected design options. The sustainability engine utilizes models relating to carbon footprint analysis, embedded carbon analysis, resource mix analysis, onsite generation analysis (e.g., wind or photovoltaic-based power), or Combined Heat & Power (CHP) feasibility analysis. And further with respect to certification standards the sustainability engine may utilize standards and ratings based on Leadership in Energy & Environmental Design (LEED®) NC 2009, Code for Sustainable Homes (CSH), Building Research Establishment Environment Assessment Method (BREEAM), PassivHaus, or Net Zero Energy Building, or Building Research Establishment Environment Assessment Method (BREEAM). However, the conventional solutions do not address the impacts or sustainability on social and monetary aspects.

Further the ratings systems disclosed such as Building Research Establishment Environment Assessment Method (BREEAM), Leadership in Energy & Environmental Design (LEED), Building for Environmental and Economic Sustainability (BEES), EcoLab etc, are available for evaluating and optimising building (architectural) design to optimise resource and cost during construction as well as energy and water consumption during the operational stage. Further these tools require training and expertise for their use and are largely accessible only to the experts. Often, the established impact evaluation processes are based on full building assessments and are unable to estimate the impacts of built environment activities, from small scale to large scale, for example, renovation projects. Further, the established impact evaluation processes and tools are unable to estimate the impacts of a single material choice across multiple dimensions of impact, in which each of the dimensions has at least a relationship or overlapping with another dimension. Over the years, some of the tools are developed to produce impact outputs for the product selection across multiple dimensions of impact. However, these tools are usually limited to only one or two dimensions. For example, recently developed tools lack the consideration of the social and monetary impacts on sustainability.

Furthermore, the global value chain is complex and the impacts of material selection and installation on different dimensions are often impalpable. This makes it challenging, particularly for individual users to realise the wider benefits and impacts that construction activities of small-scale projects can have on the environment, community, on their health and long term and short-term economic implications for themselves and the industry at large.

Therefore, there is need for a tool/framework to help individual users understand of the wider impact of decisions pertaining to products for various projects across the four dimensions of environment, social, health and monetary impacts.

### SUMMARY

This summary is provided to introduce concepts related to a system and method to determine sustainability of a project, and the concepts are further described below in the detailed description. This summary is not intended to identify essential features of the claimed subject matter nor is it intended for use in determining or limiting the scope of the claimed subject matter.

In an aspect of the present disclosure, a method for automatically providing an impact index for a product is disclosed. The method comprises the steps of selecting at least one product from a plurality of products, identifying a plurality of attributes related to a plurality of impact dimensions for the at least one product selected, selecting at least one set of attributes from the plurality of attributes for the at least one product selected, mapping the at least one set of attributes selected to a plurality of variables related to each of the plurality of impact dimensions, for the at least one product, determining a plurality of weightages for the plurality of variables and the plurality of attributes and automatically determining an impact index of the at least one product for each of the plurality of impact dimensions using the plurality of weightages.

In another aspect of the present disclosure, a system for automatically providing an impact index for a product is disclosed. The system comprises a plurality of hardware modules, at least one processor (202) configured to communicate with the plurality of hardware modules, an input/output (I/O) interface (204) configured to communicate with the at least one processor, a memory unit (206) configured to communicate with the at least one processor.

The at least one processor is configured to select at least one product from a plurality of products, identify a plurality of attributes related to a plurality of impact dimensions for the at least one product selected, select at least one set of attributes from the plurality of attributes for the at least one product selected, map the at least one set of attributes selected to a plurality of variables related to each of the plurality of impact dimensions, for the at least one product, determine a plurality of weightages for the plurality of variables mapped, and at least one set of attributes and automatically determine an impact index of the at least one product for each of the plurality of impact dimensions using the plurality of weightages, for the plurality of variables mapped.

In another aspect of the present disclosure, a system to determine sustainability of a project across a plurality of impact dimensions is disclosed. The plurality of impact dimensions comprise at least four dimensions not limited to environmental, social, health and economic impacts. In accordance with the implementation at least one product from a plurality of products being used in the construction or renovation project being performed is selected. Further a final matrix generated for the product is selected. An evaluation and weightage module (216) are configured to perform binary evaluation and assign weightage to the at least one set of attributes. Further, the at least one set of attributes are segregated and are mapped to various sustainability factors using an environment sustainability module (218), a social sustainability module (220), a health sustainability module (222), and a monetary sustainability module (224).

### BRIEF DESCRIPTION OF THE DRAWINGS

FIG. 1 illustrates a method for automatically providing an impact index for a product in accordance with the exemplary embodiment of the present disclosure.

FIG. 2 illustrates a system for automatically providing an impact index for a product in accordance with the present disclosure.

FIG. 3 illustrates an exemplary flow chart for determining scores for evaluated materials against a plurality of impact dimensions in accordance with the present disclosure.

FIG. 4 illustrates a flow chart for generating a final evaluation matrix from a plurality of attributes and variables, in accordance with the present disclosure.

FIGS. 5-8 illustrate Tables indicating material attributes reduce negative impacts in Environmental, Social, Health and Economic impacts in accordance with exemplary implementations of the present disclosure.

FIG. 9 illustrates an exemplary mapping of attributes, variable and sustainability factors in accordance with exemplary implementations of the present disclosure.

FIG. 10 illustrates environmental impact results of the four flooring options according to one of the conventional established tools.

FIG. 11 illustrates environmental impact results of the four flooring options according to another conventional established tool.

FIG. 12 illustrates comparison of results of the present invention for the environmental benefit for three alternate materials in accordance with exemplary implementations of the present invention.

It should be appreciated by those skilled in the art that any block diagrams herein represent conceptual views of illustrative systems embodying the principles of the present invention. Similarly, it will be appreciated that any flowcharts, flow diagrams, and the like represent various processes which may be substantially represented in computer readable medium and so executed by a computer or processor, whether or not such computer or processor is explicitly shown.

### DETAILED DESCRIPTION

The present invention discloses a system and method for automatically providing an impact index for a product or a material across a plurality of impact dimensions. The impact index of the product is a sustainability score determined across the plurality of impact dimensions. The product or material is selected from a plurality of products or materials available in a data base. The product or the material is selected for completing a job or use in an industry. The present invention further helps individual users understand the wider impact of decisions pertaining to the industry or jobs across the plurality of impact dimensions. In the present invention, the sustainability score across the plurality of impact dimensions is determined for a specific product selected by a user.

The words “generating”, “extracting”, “computing” “determining”, and other forms thereof, are intended to be equivalent in meaning and be open ended in that an item or items following any one of these words is not meant to be an exhaustive listing of such item or items or meant to be limited to only the listed item or items. It must also be noted that as used herein and in the appended claims, the singular forms “a”, “an” and “the” include plural references unless the context clearly dictates otherwise. The term “Economic” and “Monetary” are interchangeably used in the entire description, analysis, and examples of the present invention. Similarly, the term “Social” and “Community” are interchangeably in the entire description, analysis, and examples of the present invention. Further, the term “impacts” is interchangeably used with the term “indicators” in the entire description.

Various modifications to the embodiment will be readily apparent to those skilled in the art and the generic principles herein may be applied to other embodiments. However, one of the ordinary skills in the art will readily recognize that the present disclosure for determining a sustainability score a plurality of products or product categories selected for any kind of projects, based on a plurality of attributes mapped with a plurality of factors or variables associated with the sustainability.

The present invention provides impacts of materials/products on the choice or selection of the user, the local community within that the material will be installed and used, the region in which, the material will be procured and disposed and various planetary systems. To connect these plurality scales of impact, in the present invention, four impact dimensions are established and used. The four impact dimensions are Environmental, Social, Health and Monetary or Economic impacts (ESHM). The four dimensions are otherwise called as ‘Benefits’ for when the impact is positive.

Thus, in the present invention, the sustainability score across four impact dimensions including environmental, social, health and economic impacts is determined for the specific product selected by a user. A plurality of attributes of each product in the data base is determined and then, a set of attributes that influencing environmental, social, health and economic impacts are determined for obtaining the final sustainability score for each product. In an example, the user may select a building material for a construction of a house from a list of materials of the data base. Alternatively, the user may select the building material for use in a research and development.

In an example, the user may select a building material for a construction of a house from a list of materials of the data base. Alternatively, the user may select the building material for use in a research and development. a system and method to determine a sustainability score for construction and/or renovation projects based on a plurality of attributes mapped with a plurality of factors associated with sustainability. The system and method further help individual users understand the wider impact of decisions pertaining to construction and/or renovation projects across the four dimensions of environment, social, health and economic impacts.

In accordance with an exemplary embodiment of the present disclosure, a system and method for automatically providing an impact index for a product or a material across a plurality of impact dimensions are disclosed. The present invention helps the user to select an appropriate product to be used for the job or industry based on a region and a local community within which the product or material will be installed and used, or in which the product or material will be procured and disposed. The present invention further discloses a system and method for automatically displaying the impact index of the selected product across the environmental, social, health and economic impacts to the user.

In a further embodiment, a relative Index of the selected product for each dimension is determined by comparing the impact index of the selected product for the job with a baseline product used for the same job. Thus, the relative indexes of the product for environmental, social, health and economic impacts are determined. The baseline product is a product vastly and commercially used in the market for the job or in the industry, however, the baseline product may not be sustainable. The relative index is called as a benefit index or a reward for the selected product. The relative indexes of the product are determined across the environmental, social, health and economic impacts and displayed to the user.

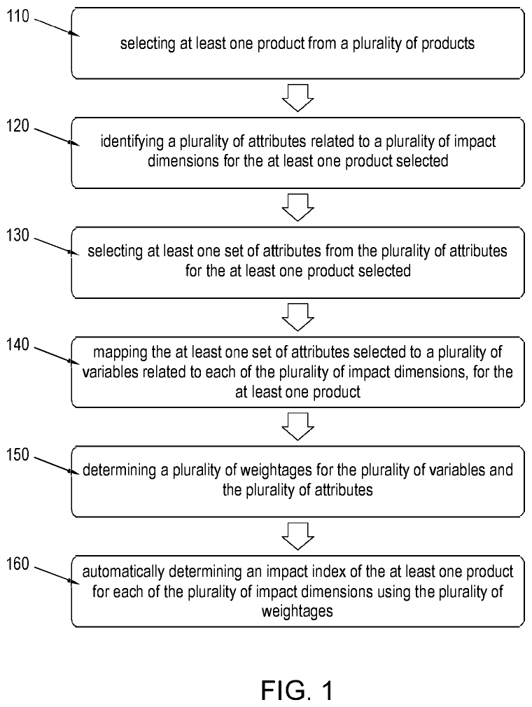

In one embodiment of the present disclosure, a method for automatically providing an impact index for a product is disclosed. The method is implemented by a system comprising one or more hardware modules. The method is configured to incorporate as a plurality of computer readable instructions that are executable by one or more processing devices to perform operations of the method. Further, the plurality of computer readable instructions are configured to store in one or more one or more non-transitory machine-readable storage. Referring to FIG. 1, illustrates a flow chart of a method for automatically providing an impact index for a product in accordance with the exemplary embodiment of the present disclosure. The method comprises the steps of selecting at least one product from a plurality of products (110), identifying a plurality of attributes related to a plurality of impact dimensions for the at least one product selected (120), selecting at least one set of attributes from the plurality of attributes for the at least one product selected (130), mapping the at least one set of attributes selected to a plurality of variables related to each of the plurality of impact dimensions, for the at least one product (140), determining a plurality of weightages for the plurality of variables and the plurality of attributes (150), and automatically determining an impact index of the at least one product for each of the plurality of impact dimensions using the plurality of weightages (160).

The impact index is a sustainability score of the product for the each of the plurality of impact dimensions. Further, the determined impact index of the at least one product for each of the plurality of impact dimensions is displayed to the user. The method further comprises the step of generating a benefit index of the at least one product for each of the plurality of impact dimensions and displaying the benefit index of the at least one product for each of the plurality of impact dimensions to the user. The benefit index is a relative index providing a comparison of the impact index of the at least one product against the impact index of a baseline product, for each of the plurality of impact dimensions.

The method further comprises the step of iteratively selecting at least one set of attributes from the plurality of attributes for the at least one product selected. In one implementation of the present invention, at least one set of attributes from the plurality of attributes are iteratively selected for the at least one product till the plurality of variables are mapped with at least one set of attributes for all the plurality of products of the database. Further steps of the method also performed iteratively based on the set of attributes from the plurality of attributes iteratively selected. The at least one set of attributes from the plurality of attributes is selected based on a predetermined cut-off of the corresponding attribute for the at least one product selected. The predetermined cut-off of the attribute comprises not limited to a declaration from a manufacturer, service receipts, a specific region or a threshold value influencing the plurality of impact dimensions.

In one implementation of the present invention, the plurality of weightages are determined for the plurality of variables mapped using a relationship value of each of the plurality of variables. The relationship value of each of the plurality of variables is determined based on a relationship between the plurality of attributes, the plurality of variables and the plurality of impact dimensions. In one embodiment, the plurality of weightages comprises a first weightage and a second weightage. The first weightage is determined for each attribute of the at least one set of attributes selected and then the second weightage is determined for each variable of the plurality of variables using the first weightage for each attribute and the relationship value.

The impact index of the at least one product for each of the plurality of impact dimensions is determined by determining an intermediate product score for each of the plurality of impact dimensions by summing up the plurality of weightages for the plurality of variables mapped for each of the plurality of impact dimensions and normalizing the intermediate product score for each of the plurality of impact dimensions using the intermediate product score of an ideal product. The ideal product relates to a same category of at least one product selected.

The plurality of weightings of the plurality of attributes are determined by identifying and defining each attribute of at least one set of attributes, determining a contextual relationship between each of the attribute with another, determining a Structural Self-Interaction Matrix (SSIM) through the contextual relationship between each of the attribute with another, converting the Structural Self-Interaction Matrix into an initial Reachability Matrix (RM); and determining a drive-dependence power or weightage of each attribute dependent on the remaining attributes of the at least one set of attributes. The drive-dependence power or weightage is determined using each driving attribute, dependent attributes, number of dependent attributes, and a relationship between each driving attribute and each dependent attribute. The contextual relationship comprises a qualitative and quantitative relationships between each of the attribute with another attribute. In one exemplary embodiment of the present disclosure, a plurality of metrics of the driving attribute of each attribute dependent on the remaining attributes of the at least one set of attributes are determined in addition to the driving power or weightage determination. Instead of driving power, other metrics of the attributes are used for determining the plurality of weightages. Thus, the determination of weightages is using not only limited to driving power, any metric, qualitative values, or quantitative values of attributes. In the present invention, the term ‘driving power’ and ‘ drive-dependent power’ can be used interchangeably.

In another embodiment of the present disclosure, the plurality of weightages for the plurality of variables and the plurality of attributes are determined by determining at least one of relative contribution and direct contribution, of each attribute in comparison to the other attributes in the plurality of attributes, determining at least one of relative contribution and direct contribution, of each variable within each impact dimension, and determining at least one of relative contribution and direct contribution, of each variable towards each attribute. in the further embodiment of the present invention, the method comprises the steps of determining a plurality of weightages for the plurality of variables and the plurality of attributes, based on a priority of assigned to each of the plurality of impact dimensions.

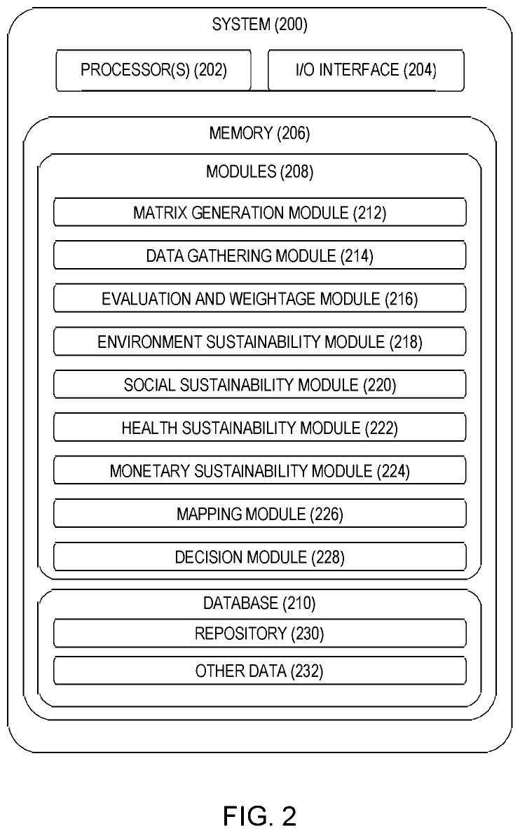

Referring to FIG. 2, illustrates a system for automatically providing an impact index for a product in accordance with the present disclosure. The impact index provides the sustainability score of the product or material in accordance with the present disclosure. The system (200) in accordance with an exemplary embodiment, comprises a plurality of hardware modules, at least one processor (202), an input/output (I/O) interface (204), and a memory unit (206). The at least one processor (202) is implemented as one or more microprocessors, microcomputers, microcontrollers, digital signal processors, central processing units, state machines, logic circuitries, and/or any devices that manipulate signals based on operational instructions. Among other capabilities, at least one processor (202) is configured to fetch and execute computer-readable instructions stored in the memory (206). The system is configured implement the various steps involved in the method for automatically providing an impact index for a product in accordance with the previous embodiment of the present disclosure.

The memory unit (206) comprises any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. The memory unit (206) includes modules (208), and database (210).

The database (210), amongst other things, serve as a repository for storing data processed, received, and generated by one or more of the modules (208). The database (210) also includes a repository (230), and other data units (232). In one embodiment, the other data (232) includes data generated as a result of the execution of one or more modules in the modules (208).

The modules (208) include routines, programs, objects, components, data structures, and the like, which perform particular tasks, functions or implement particular abstract data types. In one implementation, the modules (208) comprises a matrix generation module (212), a data gathering module (214), an evaluation and weightage module (216), an environment sustainability module (218), a social sustainability module (220), a health sustainability module (222), a monetary sustainability module (224), a mapping module (226), and a decision module (228).

In one implementation, a user accesses the system (102) via the I/O interface (204). The user is registered using the I/O interface (204) in order to use the system (102). In one aspect, the user accesses the I/O interface (204) of the system (102) for obtaining information, providing input information, or configuring the system (102).

The I/O interface (204) include a variety of software and hardware interfaces, for example, a web interface, a graphical user interface, and the like. The I/O interface (204) allows the system (200) to interact with the user directly or through a user device. Further, the I/O interface (204) enables the system (200) to communicate with other computing devices, such as web servers and external data servers (not shown). The I/O interface (204) facilitates multiple communications within a wide variety of networks and protocol types, including wired networks, for example, LAN, cable, etc., and wireless networks, such as WLAN, cellular, or satellite. The I/O interface (204) includes one or more ports for connecting a plurality of devices to one another or to another server.

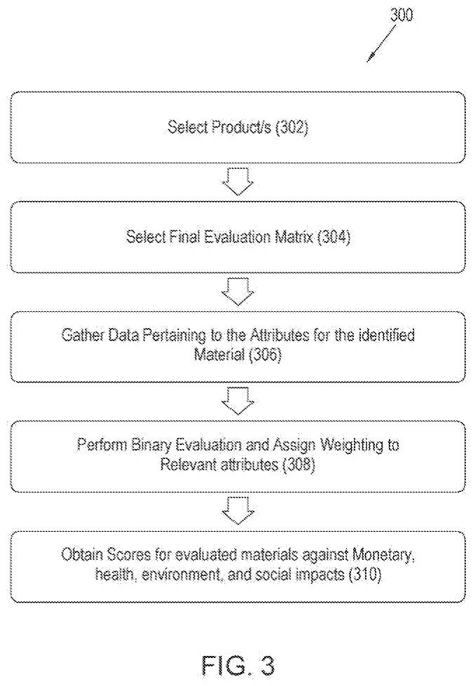

Referring to FIG. 3, illustrates an exemplary flow chart for determining scores for evaluated materials against a plurality of impact dimensions in accordance with the present disclosure. The flow chart 300 discloses selecting at least one product from various products being used in the construction or renovation project being performed at step 302. Further after selecting the product, wherein the product may relate to home appliances or constructions material including paints, a final matrix by a matrix generation module (212) is selected at step 304. Further a data gathering module (214) is configured to gather a first set of attributes, wherein the first set of attributes are specific to the selected generated final matrix at step 306. Further at step 308, an evaluation and weightage module (216) performs binary evaluation and assign weightage to the first set of attributes. At step 310, the first set of attributes are segregated and are mapped to various sustainability factors using an environment sustainability module (218), a social sustainability module (220), a health sustainability module (222), and a monetary sustainability module (224). Further, each of the sustainability module, i.e., the environment sustainability module (218), the social sustainability module (220), the health sustainability module (222), and the monetary sustainability module (224), is configured to provide summation for all the products used in the construction or renovation project under their respective sustainability factors i.e., environment, community or social, health, and Monetary.

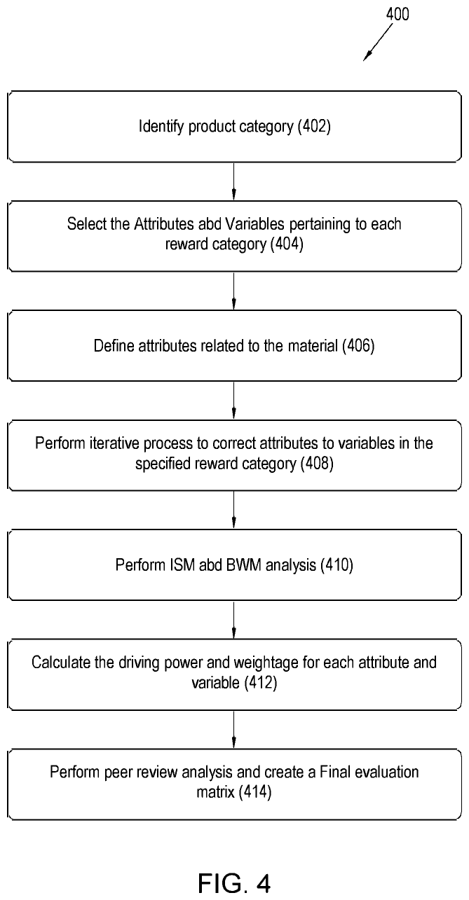

Referring to FIG. 4, illustrates a flow chart for generating a final evaluation matrix from a plurality of attributes and variables, in accordance with the present disclosure. The method 400 comprises a step 402, wherein a product selected is identified using a means for identification or selecting from a predefined list. In an exemplary embodiment, the means for identification may include a set-up comprising a camera and processing unit configured to detect the product and further identify the product using an image processing algorithm and to support the data scraping process. Further, the product refers to a home appliance or a material used for construction or renovation project being performed.

At step 404, a plurality of attributes is mapped or assigned to the product based on the identification of the product. Further each attribute from the plurality of attributes is mapped to a plurality of variables using a mapping module (226). The mapping module (226) in an exemplary embodiment, is used for mapping or assigning the plurality of attributes too. In accordance with the present disclosure, each attribute from the plurality of attributes is mapped to one or more variables from the plurality of variables and vice-versa. Further each variable from the plurality of variable is further be mapped to one more sustainability module i.e., the environment sustainability module (218), the social sustainability module (220), the health sustainability module (222), and the monetary sustainability module (224).

Further in accordance with the present disclosure, at step 406, the plurality of attributes mapped or assigned to the product are defined to obtain a first set of attributes for the identified product. At step 408, the step 406 is iteratively performed for all various products being used in the construction or the renovation project, until all the products have been mapped or assigned attributes to obtain second set of attributes, third set of attributes, fourth set of attributes and so forth sets of attributes. Further at step 410 using a decision module (228), the first set of attributes, the second set of attributes, the third set of attributes, etc are further analysed using interpretative structural modelling (ISM) and Best Worst Method (BWM). In another exemplary embodiment, the decision module (228) may implement an artificial intelligence (AI) for analysis, wherein the AI may be trained to use interpretative structural modelling (ISM) and Best Worst Method (BWM). At step 412, a driving power and weightage for each of the attribute from the set of attributes is obtained or determined. The step of determining the driving power and assigning weightage further comprises obtaining the first set of attributes using a Structural Self-Interaction Matrix (SSIM). At step 414, after performing peer review analysis, a final evaluation matrix is determined by the system.

In one exemplary implementation of the present invention, Impact indexes of the plurality of impact dimensions comprising Environment impacts, Social impacts, Health impacts, and Economic or monetary impacts are determined for a building material. Based on the latest search and existing industry-standard impact-calculators, a plurality of variables, for example 23 Variables, are determined contributing towards the four dimensions of Environment impacts, Social impacts, Health impacts and Monetary impacts. Upon analysing the influence of a pre-defined category of materials/products against these 23 Variables, the plurality of attributes inherent to building materials/products influencing the 23 variables are identified. Further, a set of most influential attributes are identified for three categories of products and defined for impact determinations. Number of variables for the selected product or category may vary based on, not limited to, the product category, new products added, research and analysis, region, future research and method of calculating weightages.

In case of building materials example, a set of attributes that determine the sustainability of building materials and are relevant to the overall sustainability of the built environment are identified, for e.g., 15 attributes were identified. Similar to variables, number of attributes the selected product or category also may vary based on, not limited to, the product category, new products added, research and analysis, region, future research and method of calculating weightages. These attributes lie across multiple lifecycles of each product or material. An interpretative structural modelling (ISM) approach was used to establish and evaluate the correlations and contribution of each attribute over a final sustainability score, to automatically determine relative quantitative value across ESHM impacts. As discussed above, the impact indexes are expressed as ‘Benefits’ if expressed as relative values compared to the impact scores of a similar product or product type that is not sustainable and very commonly used in the market. Further, a Best Worst Method (BWM) is used to modify the ranking based on ISM as per the users' criteria selection. For other categories of materials or products, the set and/or number of attributes may vary and therefore the link to the 23 variables have to be calculated iteratively using the methodology of the present invention.

Further, a structural self-interaction matrix (SSIM) for determining contextual relationships between the pair of attributes, as one attribute “influences” other and vice-versa, each of these attribute relationships were defined. Further a reachability matrix (RM) was obtained from SSIM and verified using transitivity. Further post embedding of the transitivity was completed, the matrix was then used to determine the ‘driver’ and ‘dependent’ power of the attributes, called as ‘driving power’. The ‘driving power’ is a measure of the strength of influence any particular attribute has on the remaining attributes in the matrix. Further a final matrix is generated having the weightage assigned for each attribute.

The Monetary and Health impacts refer to the individual scale, the Social impact refers to the scale of individual's community. The scale of individual's community is defined at the scale of neighbourhood, or at the scale of a region, depending on the size of the region, for example a city. The Environmental impact refers to a regional or global scale. The analysis in the present invention have performed based on positive contributions of materials to the environment, communities, health and monetary. Consequently, the term ‘impact’ is used interchangeably with the term ‘benefit’ throughout in the analysis of the present invention.

In accordance with the implementations of the present invention, Environmental impacts involve selecting materials, products and/or systems available locally in one's city, county or even country reduces the environmental impact caused by transportation. Particularly for a building product, Environmental impacts involve reclaimed building materials, as well as products manufactured using recycled materials, reduce the environmental impact of buildings by reducing waste, promoting resource efficiency, and reducing CO2 emissions due to extraction and manufacturing of new products. In an example, Environmental impacts involve easily dismantled or recovered materials, durable materials to conserve resources, save water and reduce waste going into landfills.

Social impacts involve with use of resources, materials and services available through the local supply chain helps support the growth of the local economy and strengthens the local community, use of sustainable materials and products not only benefits the occupants living in the building but also encourages the growth of sustainable business practices, use of sustainable materials and design measures makes buildings suitable for future climatic conditions such as overheating, flooding, etc. and promotes resilience. For example, social impacts involve avoiding the use of materials and products that emit high levels of harmful chemicals, such as VOCs, heat island effects, glare, noise and light pollution would be beneficial for existing as well as for future occupiers of the building.

Health impacts involve involves ensuring healthy lives and promoting wellbeing for all is one of the Sustainable Development Goals laid out by the UN, creating buildings that promote health and wellbeing of the occupants not only helps the individuals but also contributes towards sustainable growth on a global level. For example, indoor pollutants may affect the health of the occupants and insulating walls, preventing leakage and investing in good quality windows improve the health of the occupants. The use of materials that are moisture balancing and incorporating adequate ventilation strategies in the home can prevent dampness and condensation. Health impacts considers the short-term and long-term health impacts on the occupants.

Economic impacts involve monetary benefits, for example sustainable buildings save money through reduced energy consumption for heating, cooling and lighting the building, reduced water usage save money for day-to-day activities, Lower long-term operations and maintenance costs help save money throughout the lifecycle of the building.

With growing awareness and concern about the environmental and social impacts of the built environment, buildings with better sustainability credentials enjoy increased marketability and higher asset values than their conventional code compliant counterparts. Studies around the world have shown that energy efficient buildings more easily attract tenants and buyers to command higher rents and sale prices. Sustainable buildings contribute to the health and wellbeing of the occupants thereby reducing visits to seek medical aid. Energy savings in sustainable buildings typically exceed any design and construction cost premiums within a reasonable payback period. Using efficient and durable building materials and products not only improves the life of the building but also addresses extra cost required for frequent up-keep and maintenance.

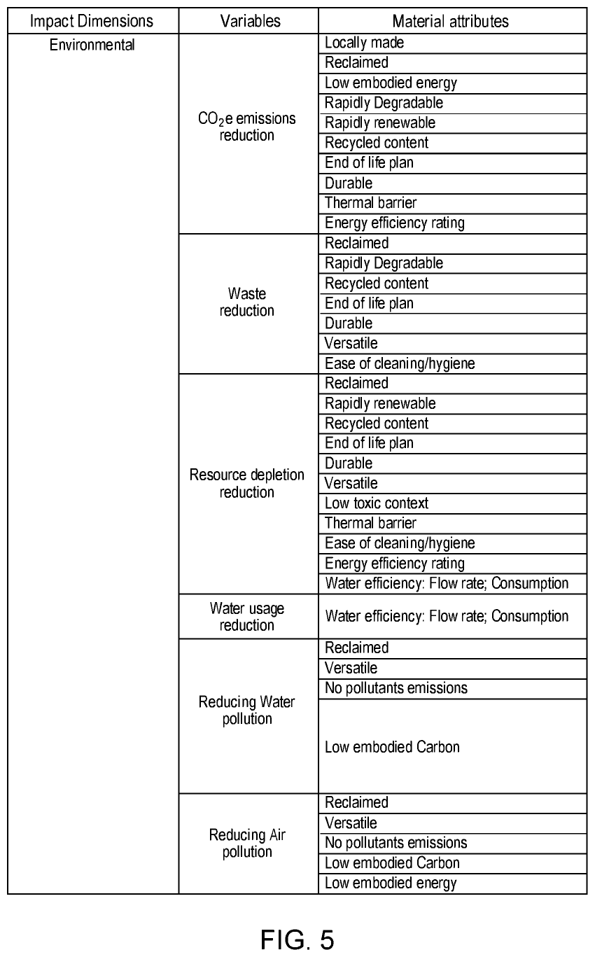

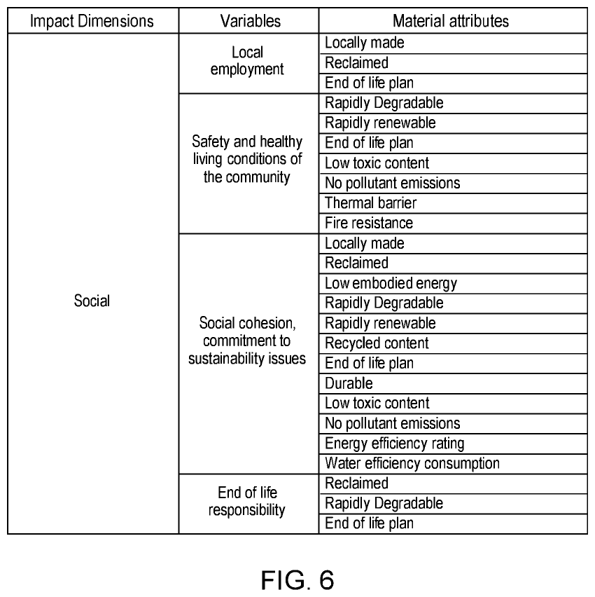

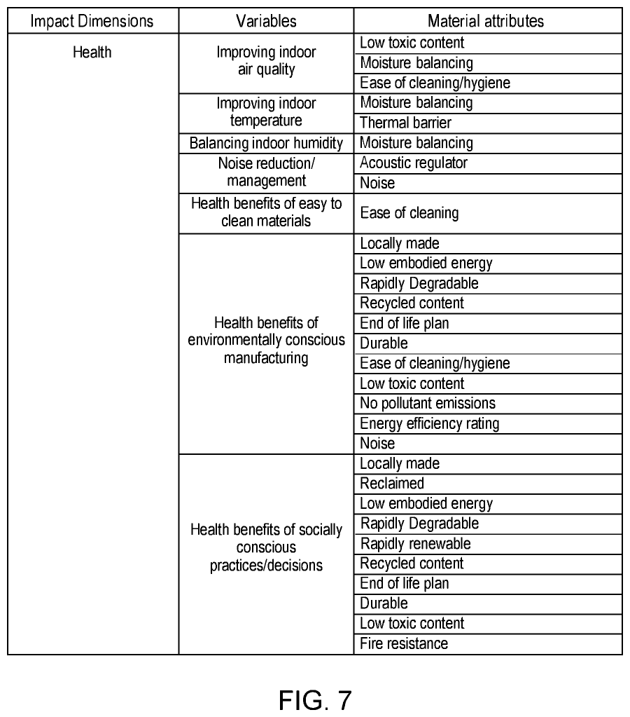

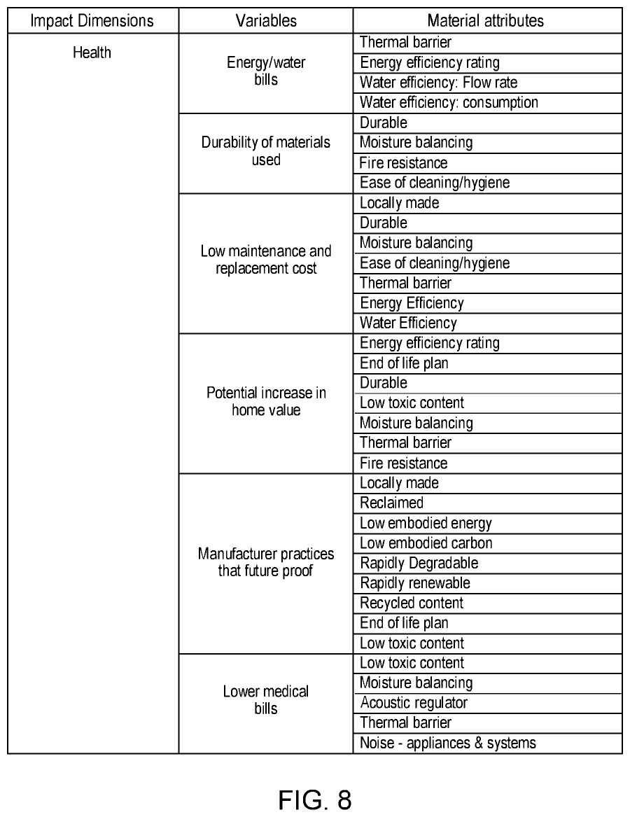

The Environmental, Social, Health and Economic impacts are identified as Benefits on the Environment, Social, Health and Monetary. Referring to FIGS. 5-8, illustrate Tables indicating material attributes reduce negative impacts in Environmental, Social, Health and Economic impacts. FIG. 5 illustrates the plurality of Variables and Material attributes for Environmental Benefits in accordance with the example of the present disclosure. FIG. 6 illustrates plurality of Variables and Material attributes for Social Benefits in accordance with the example of the present disclosure. FIG. 7 illustrates plurality of Variables and Material attributes for Health Benefits in accordance with the example of the present disclosure. FIG. 8 illustrates plurality of plurality of Variables and Material attributes for Monetary Benefits in accordance with the example of the present disclosure. In the examples of the present invention, these relationships were studied through a series of influencing factors identified for each impact.

The present invention identifies a plurality of attributes of the product representing a holistic measure of sustainability of various built environment activities. Depending on the context and the aim of the project, there is a wide range of attributes that uses expert opinions from various built environment professionals, including builders, architects, and manufacturers, use for decision-making. In the present invention, different attributes but not always mutually exclusive set of attributes pertaining to materials and products are identified. The Attributes for evaluating different products and materials are identified and selected to meet that (I) the attributes were chosen to cover the impact of built environment activities in all dimensions, including the environmental impacts due to extraction, processing, manufacturing; transportation and disposal of materials, (ii) Making the users aware of the attributes of sustainable materials and the benefits they can gain by selecting them, will not only assist them in making the right choice, but will also lead to an increased demand for sustainable construction, business and practices.

In other examples of the present invention, a plurality of Attributes for three categories of materials/products in domestic construction were identified. In the examples, categories of ‘Generic Building Materials’, ‘Water Fixtures, Fittings and Plumbing’ and ‘Electric Appliances, Systems & Lighting’ were considered. For example, ‘Building Materials’ category includes but not limited to structural materials, finishes, insulation products, plumbing category includes but not limited to toilette fixtures and pipes and ‘Electric Appliances’ category includes but not limited to products such as kitchen appliances, electric systems, heating systems and lighting bulbs.

For the category of Generic Building Materials example, a set of 15 Attributes for building materials were identified, including aspects of material's lifecycle, performance, and the impact on users. The identification of attributes was based on reviewing existing environmental assessment methods, such as LEED, BREEAM, HQM, WELL, Living Building Challenge and Passivhaus, and literature on criteria used to define the sustainability of materials and products. The 15 attributes for products of Generic Building Materials are Locally made, Reclaimed, Low embodied energy, Low embodied carbon, Rapidly Degradable, Rapidly Renewable, Recycled content, End of life plan, Durable, Versatile, Low Toxic content, Moisture balancing, Acoustic regulator, Thermal barrier, Fire resistance. As discussed in the above, number of attributes for products and selection of attributes for a category may vary based on a user requirement, new products added in the category, region of the products, further research and analysis, and methods of calculating weightages.

Further in the present invention, three example attributes from the 15 attributes are defined along with cut off value considered for each attribute to be applicable for the selected product/material are given below:

1. Locally made: Products that have been extracted and/or manufactured using resources available within a defined distance from the project site.
Location of manufacturing units matter as some manufacturers can be operating from a particular region or selected region, for example, United Kingdom or USA, however, the manufacturing units may be located far away in another country, which does not qualify as locally made.

Cut off: Manufacture declaration that the product was manufactured within the selected region.

2. Reclaimed: Materials and products that are previously used in buildings, temporary works or other projects, and which are then either slightly altered, re-sized, refinished or adapted to be used again.

Cut off: Manufacturer claim or evidence that the product is a second-hand product—and the product has not undergone any major alterations in order for it to be reused.

3. Low embodied energy: The embodied energy of a material or product is the total amount of primary energy consumed during its whole life cycle, including extraction, manufacturing, construction, maintenance, and disposal.
The low embodied energy attribute is predominantly looking at the stages A1-A3 of the manufacturing process.

Cut off: Cut off values vary across different product types, the calculated appropriate cut off values are:
Cladding: 152.631 MJ/m²
Flooring: 158.481 MJ/m²
Insulation: 204.982 MJ/m²
Interior finishes: 104.378 MJ/m²
Roofing: 95.495 MJ/m²
Structure: 217.868 MJ/m²

For the Electric Appliances, Systems & Lighting category example, a set of 10 Attributes including aspects of material's lifecycle, performance, and the impact on users were identified. For evaluating the products under the category, the shared attributes comprising Locally made, Recycled content, EoL plan, Durable, Versatile, Low embodied carbon, were considered. Further unique attributes related to electric appliances, comprising Energy efficiency, Water consumption efficiency, Noise and No pollutant emissions were considered.

For the Water Fixtures, Fittings & Plumbing example, a set of 7 Attributes, including aspects of material's lifecycle, performance, and the impact on users were identified. For evaluating Water Fixtures, Fittings & Plumbing category, the shared attributes comprising Locally made, Reclaimed, EoL plan Durable, Low embodied carbon and the unique attributes comprising Water efficiency—Flow rate: and Ease of cleaning/hygiene were considered.

All the attributes of the product may not create an equal impact on Environmental, Social, Health and Economic impacts. Some of the attribute may influence the dimensions more than the remaining attributes. Once a set of attributes for a specific product from the plurality of attributes are identified, relative contributions are determined to obtain a final sustainability score, which is the Impact index for the specific product, across each ESHM dimension. Determinations of relative contributions include determinations of a) the quantitative relative contribution of each attribute in comparison to the other attributes, b) the quantitative relative contribution of each variable within each benefit or dimension, and c) the quantitative relative contribution of each variable towards each attribute. The quantitative relative contribution is also called as strength of the influence of each attribute or weighting of each variable towards each benefit or attribute.

In case a new product category is selected, weightings and quantitative relative contributions are configured to get reset and recalculated. However, weightings and quantitative relative contributions remain unchanged for that specific category at that point until new updates on Environmental, Social, Health and Economic impacts.

The process of determining weightings for the plurality of attributes is explained in detail in the further description. The relative contributions or weightings of the selected sustainability attributes are determined using an Interpretive Structural Modelling (ISM) approach. The Interpretive structural modelling (ISM) is a well-established process for identifying relationships among specific elements (Warfield J. N., 2003), in our disclosure Attributes, defining a problem or an issue. For example, sustainability of buildings. The ISM approach is an interactive learning process, allowing the representation of several directly and indirectly related elements of a complex topic or problem, in a comprehensive systematic model. In the ISM approach, the following steps were followed:
i. Identifying the elements (in this case attributes) for analysis
ii. Developing a Structural Self-Interaction Matrix (SSIM)
iii. Developing the Reachability Matrix (RM)
iv. Calculating the drive-dependence power/driving power to obtain relative weightings for the attributes

In the below section, determination of relative weighting of attributes selected for evaluating building materials and products are discussed. A similar process is also applied for calculating the weightings of Attributes for multiple categories of products, including but not limited to Electric Appliances, Systems & Lighting, and Water Fixtures, Fittings & Plumbing.

In the method of determination of weightings, Initially, for each product Category or a product, a set of attributes from list of attributes are identified. For example, for the case of the Generic Building Materials, 15 attributes were identified and defined.

The Structural Self-Interaction Matrix (SSIM) determines inter-relationship between each of the attribute, from the plurality of attributes. In accordance with an exemplary embodiment, a data set can be created using expert opinion and then contextual relationships between a pair of attributes are determined, as one attributes “influences” other and vice-versa. Further the relationship between the pair of attributes are illustrated and represented as below:
When attribute “i” influences attribute “j”, the relationship is indicated by letter “V”;
When attribute “i” is influence by attribute “j”, the relationship is indicated by letter “A”;
When both attribute “i” and attribute “j” influence each other, the relationship is indicated by letter “X”; and
When both attribute “i” and attribute “j” do not have any influence on each other, the relationship is indicated by letter “O”.

Further in accordance with the exemplary embodiment, an initial reachability matrix (RM) is obtained by converting the Structural Self-Interaction Matrix. The reachability matrix (RM) is obtained by substituting “V”, “A”, “X”, and “O” into corresponding binary values of “0” and “1”. For e.g.:
If, (i, j) entry in the SSIM=V, then the (i, j) entry in the RM=1 and the corresponding (j, i) entry in the RM=0.
If (i, j) entry in the SSIM=A, then the (i, j) entry in the RM=0 and the corresponding (j, i) entry in the RM=1.
If (i, j) entry in the SSIM=X, then the (i, j) entry in the RM=1 and the corresponding (j, i) entry in the RM=1.
If (i, j) entry in the SSIM=O, then the (i, j) entry in the RM=0 and the corresponding (j, i) entry in the RM=0.

This initial reachability matrix denotes only the direct relationships between the attributes. Therefore, a transitivity check was performed to account for any indirect influence that the different attributes had on each other. The transitivity was indicated in the initial RM by replacing the existing 0 with 1. Equation 1 shows an example of the application of transitivity check.

If, F1→F2, and F2→F4,F8

Then F1→F4,F8 (1)
Where, F1, F2, F3 . . . n correspond to the attributes.
   The final RM uses the value 1 for whether the relationship exists (both directly and indirectly) or the value 0 for when the relationship does not exist.

Once the final RM was completed, the RM matrix was then used to calculate the ‘driving power’ of each Attribute. Further ‘driver’ and ‘dependent’ power for each of the plurality of attributes are calculated. The ‘weighing power’ or ‘driving power’ is defined as measure of the strength of influence that any particular attribute has on the remaining attributes in the RM matrix. It is calculated as the sum of the existing direct and indirect relationships between attributes, established as 1 or 0. The following equation is used to calculate ‘driver’ and ‘dependent’ power:

$$\begin{matrix}DRi = {\sum }_{j = 1}^{n} {m}_{i , j} , & i = 1 , 2 , 3. . n\end{matrix} \qquad ( 2 )$$

### Where

DRi is the driving power of the attribute,
i is the driver attribute,
j is the dependent attribute,
n is the number of dependent attributes the driver attribute is being compared to and
m is the relationship between each driving attribute and each dependent attribute, which can be 0 or 1, according to the Reachability Matrix (Step 3).

As a result of determinations in the above sections, the weightings for each of the attributes for evaluating ‘Generic Building Materials’ are expressed in a table below. Further the below table illustrates driver power i.e., driving power/weightage assigned to each attribute:

| No. | Attributes | Driving power (Weighting) |
|---|---|---|
| 1 | Locally made | 0.07 |
| 2 | Reclaimed | 0.09 |
| 3 | Low embodied energy | 0.06 |
| 4 | Low embodied carbon | 0.01 |
| 5 | Rapidly Degradable | 0.12 |
| 6 | Rapidly Renewable | 0.06 |
| 7 | Recycled content | 0.02 |
| 8 | End of life plan | 0.04 |
| 9 | Durable | 0.09 |
| 10 | Versatile | 0.08 |
| 11 | Low Toxic content | 0.04 |
| 12 | Moisture balancing | 0.12 |
| 13 | Acoustic regulator | 0.01 |
| 14 | Thermal barrier | 0.08 |
| 15 | Fire resistance | 0.11 |

The attributes do not have the same impact on the different benefits variables, and the variables do not have the same contribution towards the benefit. The relationships between benefits, variables and attributes were discussed, reviewed and scores were allocated to each relationship using expert opinions and research, sustainability factors, under the following criteria:
a) Value “1.0”: When there is a relationship, but it is low or indirect
b) Value “2.0”: When the relationship is strong
c) Value “3.0”: When the relationship is key important
   The above multipliers affected the driving power of each attribute, according to the variable evaluated for each case. Therefore, the driving power of each attribute is affected by both, the relationship to each variable and the relationship between variables and benefits, generating a multi-value matrix of relationships when calculating the total Environmental, Social, Health and Monetary benefits. Further, the variables for each of the four dimensions of impact were linked to the product attributes.

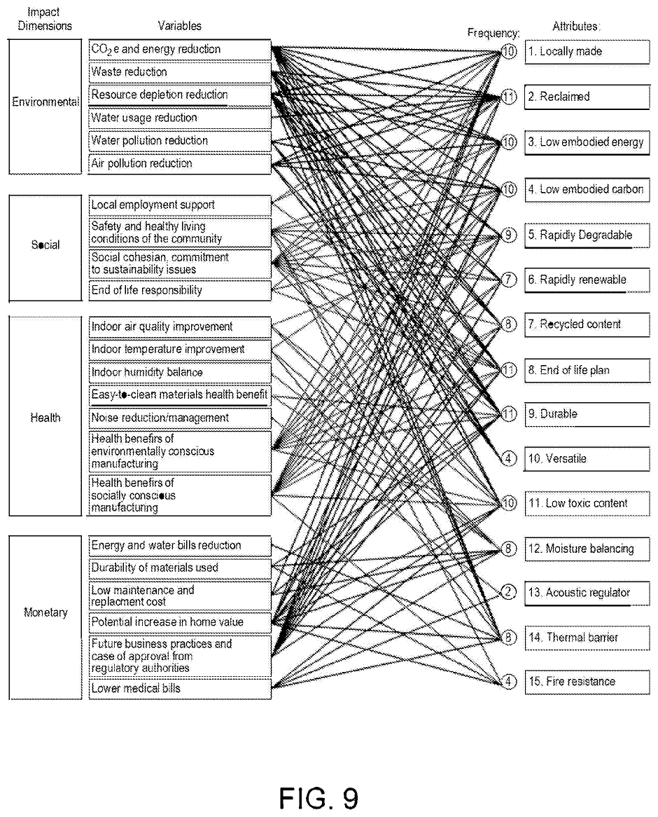

Referring to FIG. 9, illustrates an exemplary mapping of attributes, variable and sustainability factors in accordance with the present disclosure. As illustrated each attribute from the plurality of attributes may be associated or mapped with one or more variables related to benefits. Further even the variables may be further associated with one or more sustainability factors. As shown, FIG. 9 summarises linking of the attributes for Generic Building Materials to the 23 Environmental, Social, Health and Monetary variables.

When a product or material is evaluated according to the attributes of the product or material, the system determines that whether the product meets the conditions for each attribute or not.

To generate the four Environmental, Social, Health and Monetary impact scores of that product, for each ESHM impact the calculation will involve summing up the scores of its depending variables. The variable's score will be generated by summing up the weightage of all the attributes linked to that variable. When an attribute is not met, the weighting for that attribute is not included in the calculation (multiplied by 0).

For example, in the ‘Generic Building Materials’ category, if a type of flooring meets only the following attributes: Locally made (weighting: 0.07), Reclaimed (weighting: 0.09), Durable (weighting: 0.09) and Fire resistance (weighting: 0.11), the social impact of the product is calculated as the sum of the scores of the following four variables:
Variable 1 (Local employment): Locally made weighting (0.07*3.0*3.0)+Reclaimed weighting (0.09*2.0*3.0)=0.161.17
Variable 2 (Safety and healthy living conditions of the community): Fire resistance weighting (0.11*3.0*2.0)=0.1166
Variable 3 (Social cohesion, commitment to sustainability issues): Locally made weighting (0.07*2.0*1.0)+Reclaimed weighting (0.09*3.0*1.0)+Durable weighting (0.09*1.0*1.0)=0.250
Variable 4 (End of life responsibility): Reclaimed weighting (0.09*3.0*3.0)=0.0981
   The sum of these four variables is 3.13.

Further, as a final step, in order to have a comparable value between all four Environmental, Social, Health and Monetary impact scores, determined impact scores for ESHM impacts are normalized so that these scores are within a range from 0 to 10. Therefore, each final value is multiplied by the value of impact index of a “perfect product”, divided by 10 to obtain a total impact score. The perfect product is the ideal product that has all attributes for Environmental, Social, Health and Monetary. The total social impact score for the above example is 0.613.13*9.13/10=2.86. wherein the impact score of the perfect product is 9.3. Similarly, total impact scores with the other three dimensions of impacts are determined. The impact scores are expressed as Benefits if expressed as relative values compared to the impact scores of a similar product or product type which is not sustainable and very commonly used in the market.

Further, the impact scores can be personalized using a Best Worst Method (BWM). The best worst method is to further identify the user's priorities and rebalance the weightages of the attributes associated with that priority. For example, if the user's priority order is Health, Environment, Social and Monetary, then the attributes associated with Health is recalibrated to have a higher weightage than the Environment, followed by Social and finally Monetary impacts.

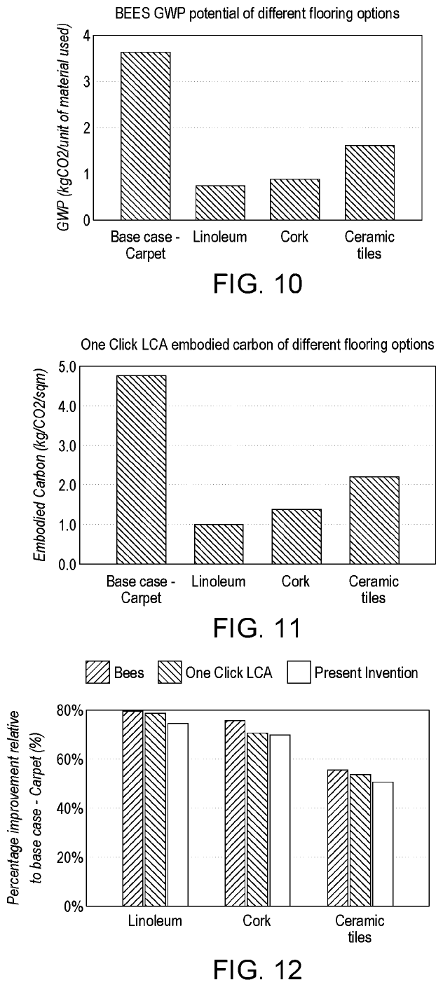

In the further implementations of the present invention, the accuracy of the present invention was validated by comparing the results of the present invention to other conventional established competitor methods such as BEES software from The National Institute of Standards and Technology (NIST), and One Click LCA. Referring to FIG. 10, illustrates environmental impact of the four flooring options according to BEES database. FIG. 10 shows Global warming potential of different flooring options from the BEES software. Referring to FIG. 11, illustrates environmental impact of the four flooring options according to One Click's LCA tool. FIG. 11 shows embodied carbon of different flooring options from One Click LCA tool.

While BEES and One Click express the results of impacts as negative impact, thus the lower the emissions the lower the impact of the material, the present invention expresses the results as positive benefits, thus the higher the bar the higher the benefits to the environment. Therefore, similarly to the results from the present invention, BEES and One Click show that among all four, linoleum is the least harmful product to the environment, followed again by cork, ceramic tiles and finally the base case, carpet. In order to compare both methods, the results were normalized in percentage of improvement, for each of the alternate materials against the base case. FIG. 12 illustrates comparison of results for the environmental benefit for three alternate materials. For the three alternate materials, the difference between the results from both methods was less than 4%. The low percentage difference demonstrates that the results from both methods are aligned, and the alignment validates the present invention against the established competitor methods. It was observed that BEES and One Click LCA cannot be used to compare the Social, Health and Monetary benefits, as it only analyses the environmental dimension of sustainability.

During the research, analysis, and comparisons, it was observed that there is no tool assessing sustainability of materials holistically exist. It was further observed that all the standards and certifications analysed (BREEAM, HQM, LEED & WELL) fail to examine many of variables that presented method considers when calculating their respective scores, ending up with a score that is partial, and which does not reflect a broad and holistic impact of the building.

The present invention discloses a method and system to determine the individual weightage of attributes and combined weightage of variables to obtain a final benefit calculation, as an iterative process for the plurality of impact dimensions. The disclosure does not limit the exact definitions or specific weightings of attributes. Benchmarks of sustainability and attributes may change depending on the materials analysed and their application. The presented method is used to determine impact holistically for any manufactured product that claims to be sustainable in any industry.

The present invention improves the efficiency of calculating sustainability benefits. Further using the Best Worst Method (BWM), weightings calculated can be adjusted to meet the users' criteria and priorities. The present invention provides a unique solution compared to the existing sustainability estimation methodologies because the present invention displays accessibility and assimilation of the information to a non-expert individual, such as a property owner. Furthermore, the present invention empowers individuals to make informed decisions considering aspects, therefore individuals have a tool to make sustainable choices according to their own priorities and particular drivers.

The above description along with the accompanying drawings is intended to disclose and describe the preferred embodiments of the invention in sufficient detail to enable those skilled in the art to practice the invention. It should not be interpreted as limiting the scope of the invention. Those skilled in the art to which the invention relates will appreciate that many variations of the exemplary implementations and other implementations exist within the scope of the claimed invention. Various changes in the form and detail may be made therein without departing from its spirit and scope. Similarly, various aspects of the present invention may be advantageously practiced by incorporating all features or certain sub-combinations of the features.

1. A method for automatically providing an impact index for a product, the method comprising the steps of:
selecting at least one product from a plurality of products provided in a predefined list;
identifying a plurality of attributes related to a plurality of impact dimensions for the at least one product selected, wherein the plurality of impact dimensions comprise Environmental impacts, Social impacts, Health impacts, and Economic impacts;
selecting at least one set of attributes from the plurality of identified attributes related to the plurality of impact dimensions for the at least one product selected;
mapping the at least one set of attributes selected to a plurality of variables related to each of the plurality of impact dimensions, wherein the plurality of variables comprise a plurality of sustainability factors associated with the plurality of impact dimensions, each variable is mapped with one or more relevant attributes of the selected product;
determining a plurality of weightages for the plurality of mapped variables and the at least one set of attributes related to the plurality of impact dimensions; and
automatically determining an impact index of the at least one product for each of the plurality of impact dimensions using the plurality of weightages.

2. The method as claimed in claim 1, wherein the impact index is a sustainability score of the product for the each of the plurality of impact dimensions.

3. The method as claimed in claim 1, wherein the method further comprises the step of displaying the impact index of the at least one product for each of the plurality of impact dimensions.

4. The method as claimed in claim 1, wherein the method further comprises the step of generating and displaying a benefit index of the at least one product for each of the plurality of impact dimensions.

5. The method as claimed in claim 4, wherein the benefit index is a relative index providing a comparison of the impact index of the at least one product against the impact index of a baseline product, for each of the plurality of impact dimensions.

6. The method as claimed in claim 1, wherein the at least one set of attributes from the plurality of attributes is selected based on a predetermined cut-off of the corresponding attribute for the at least one product selected.

7. The method as claimed in claim 6, wherein the predetermined cut-off of the attribute is selected from a group comprising a geo-graphical region, a local community, a region of manufacture, a document related to the product, and a threshold value influencing the plurality of impact dimensions and variables.

8. The method as claimed in claim 1, wherein the method further comprises the step of receiving at least one input data from a user through an input/output (I/O) interface, wherein the input data comprises an information of at least one product selected by the user.

9. The method as claimed in claim 1, wherein selecting at least one product from a plurality of products provided in a predefined list comprises:
receiving at least one input data from a user through an input/output (I/O) interface;
detecting at least one product from the predefined list based on the input data; and
identifying the product using an image processing method by a camera and at least one processor of a system.

10. The method as claimed in claim 1, wherein the method further comprises the step of iteratively selecting at least one set of attributes from the plurality of attributes for the at least one product selected.

11. The method as claimed in claim 8, wherein the at least one set of attributes are iteratively selected till the plurality of variables are mapped with at least one set of attributes for all the plurality of products.

12. The method as claimed in claim 1, wherein the impact index of the at least one product for each of the plurality of impact dimensions is automatically determined by processing the plurality of variables for each of the plurality of impact dimensions.

13. The method as claimed in claim 1, wherein determining a plurality of weightages for the plurality of mapped variables comprises the step of:
determining a relationship value of each of the plurality of variables based on a relationship between the plurality of attributes, the plurality of variables and the plurality of impact dimensions;
determining a first weightage for each attribute of the at least one set of attributes selected based on strength and influence of each attribute with other attributes; and
determining a second weightage for each variable of the plurality of variables using the first weightage for each attribute and the relationship value.

14. The method as claimed in claim 1, wherein automatically determining an impact index of the at least one product for each of the plurality of impact dimensions comprises the step of:
determining an intermediate product score for each of the plurality of impact dimensions by summing up the plurality of weightages for the plurality of mapped variables for each of the plurality of impact dimensions; and
determining the impact index of the at least one product for each of the plurality of impact dimensions by:
normalizing the intermediate product score for each of the plurality of impact dimensions using the intermediate product score of an ideal product,
wherein the ideal product relates to a same category of at least one product selected.

15. The method as claimed in claim 1, wherein determining the plurality of weightings of the at least one set of attributes comprises the steps of:
identifying and defining each attribute of at least one set of attributes;
determining a contextual relationship between each of the attribute with another, wherein the contextual relationship comprises a qualitative and quantitative relationships between each of the attribute with another attribute;
determining a Structural Self-Interaction Matrix (SSIM) through the contextual relationship between each of the attribute with another;
converting the Structural Self-Interaction Matrix into an initial Reachability Matrix (RM); and
determining a drive-dependence power or weightage of each attribute dependent on the remaining attributes of the at least one set of attributes, wherein the drive-dependence power or weightage is determined using each driving attribute, dependent attributes, number of dependent attributes, and a relationship between each driving attribute and each dependent attribute.

16. The method as claimed in claim 1, wherein determining a plurality of weightages for the plurality of mapped variables and the at least one set of attributes comprises the steps of:
determining at least one of relative contribution and direct contribution, of each attribute in comparison to the other attributes in the plurality of attributes;
determining at least one of relative contribution and direct contribution, of each variable within each impact dimension; and
determining at least one of relative contribution and direct contribution, of each variable towards each attribute.

17. The method as claimed in claim 1, wherein the method further comprises the steps of:
determining a plurality of weightages for the plurality of variables and the plurality of attributes, based on a priority of assigned to each of the plurality of impact dimensions.

18. A system for automatically providing an impact index for a product, the system comprising:
a plurality of hardware modules;
at least one processor (202) configured to communicate with the plurality of hardware modules;
an input/output (I/O) interface (204) configured to communicate with the at least one processor;
a memory unit (206) configured to communicate with the at least one processor; wherein the at least one processor is configured to:
select at least one product from a plurality of products provided in a predefined list;
identify a plurality of attributes related to a plurality of impact dimensions for the at least one product selected;
select at least one set of attributes from the plurality of identified attributes for the at least one product selected;
map the at least one set of attributes selected to a plurality of variables related to each of the plurality of impact dimensions, wherein the plurality of variables comprise a plurality of sustainability factors associated with the plurality of impact dimensions, each variable is mapped with one or more relevant attributes of the selected product; and
determine a plurality of weightages for the plurality of variables mapped, and at least one set of attributes related to the plurality of impact dimensions;
automatically determine an impact index of the at least one product for each of the plurality of impact dimensions using the plurality of weightages for the plurality of variables mapped, wherein the plurality of impact dimensions comprise Environmental impacts, Social impacts, Health impacts, and Economic impacts.

19. The system as claimed in claim 18, wherein the plurality of hardware modules comprise a matrix generation module (212), a data gathering module (214), an evaluation and weightage module (216), an environment sustainability module (218), a social sustainability module (220), a health sustainability module (222), a monetary sustainability module (224), a mapping module (226), and a decision module (228).

20. The system as claimed in claim 18, wherein the system further comprises a database (210).

21. The system as claimed in claim 18, wherein the impact index of the at least one product is displayed for each of the plurality of impact dimensions.

22. The system as claimed in claim 18, wherein a benefit index of the at least one product is generated for each of the plurality of impact dimensions.

23. The system as claimed in claim 18, wherein the benefit index is a relative index providing a comparison of the impact index of the at least one product against the impact index of a baseline product, for each of the plurality of impact dimensions.
